(19) United States
(12) Patent Application Publication
(10) Pub. No.: US 2025/0358725 A1
(43) Pub. Date: Nov. 20, 2025

(54) CELL SHARING FOR ENHANCED USER EQUIPMENT CONNECTION

(71) Applicant: QUALCOMM Incorporated, San Diego, CA (US)

(72) Inventors: Ahmed BEDEWY, Hillsborough, NJ (US); Naeem AKL, Bridgewater, NJ (US); Navid ABEDINI, Basking Ridge, NJ (US); Tao LUO, San Diego, CA (US)

(21) Appl. No.: 18/666,381

(22) Filed: May 16, 2024

(51) Int. Cl. H04W 48/18; H04W 4/12; H04W 4/50; H04W 56/00

(52) U.S. Cl. CPC H04W 48/18; H04W 4/12; H04W 4/50; H04W 56/0015

(57) ABSTRACT

Methods, systems, and devices for wireless communications are described. For example, a shared network entity may provide services for multiple different network operators to a user equipment (UE). In some examples, the shared network entity may advertise a first list of services for a first network operator and a second list of services for a second operator to the UE. Additionally, or alternatively, the shared network entity may provide the second network operator information in a separate indication. In some cases, the shared network entity may transmit a list of network entity identifiers that share the same network operator as the UE and a list of network entity identifiers with a different network operator as the UE, which may enable the UE to construct an allow and block list of the network entities.

### FIELD OF TECHNOLOGY

The following relates to wireless communications, including cell sharing for enhanced user equipment connection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, a first network entity may support energy saving techniques at a second network entity.

### SUMMARY

The systems, methods, and devices of this disclosure each have several innovative aspects, no single one of which is solely responsible for the desirable attributes disclosed herein.

A method for wireless communications by a first network entity is described. The method may include transmitting first information that indicates one or more first services supported by the first network entity, where the one or more first services are associated with a first network operator, transmitting second information that indicates one or more second services supported by the first network entity, where the one or more second services are associated with a second network operator, and providing at least one service of the one or more first services or the one or more second services to a user equipment (UE), where provision of the at least one service is based on the UE being associated with the first network operator or the second network operator.

A first network entity for wireless communications is described. The first network entity may include one or more memories storing processor executable code, and one or more processors coupled with the one or more memories. The one or more processors may individually or collectively be operable to execute the code to cause the first network entity to transmit first information that indicates one or more first services supported by the first network entity, where the one or more first services are associated with a first network operator, transmit second information that indicates one or more second services supported by the first network entity, where the one or more second services are associated with a second network operator, and provide at least one service of the one or more first services or the one or more second services to a UE, where provision of the at least one service is based on the UE being associated with the first network operator or the second network operator.

Another first network entity for wireless communications is described. The first network entity may include means for transmitting first information that indicates one or more first services supported by the first network entity, where the one or more first services are associated with a first network operator, means for transmitting second information that indicates one or more second services supported by the first network entity, where the one or more second services are associated with a second network operator, and means for providing at least one service of the one or more first services or the one or more second services to a UE, where provision of the at least one service is based on the UE being associated with the first network operator or the second network operator.

A non-transitory computer-readable medium storing code for wireless communications is described. The code may include instructions executable by one or more processors to transmit first information that indicates one or more first services supported by the first network entity, where the one or more first services are associated with a first network operator, transmit second information that indicates one or more second services supported by the first network entity, where the one or more second services are associated with a second network operator, and provide at least one service of the one or more first services or the one or more second services to a UE, where provision of the at least one service is based on the UE being associated with the first network operator or the second network operator.

In some examples of the method, first network entities, and non-transitory computer-readable medium described herein, transmitting the first information and transmitting the second information may include operations, features, means, or instructions for transmitting a first message including the first information and an indication that the second information may be in a second message, where provision of the at least one service of the one or more first services may be based on the first message and transmitting the second message including the second information.

In some examples of the method, first network entities, and non-transitory computer-readable medium described herein, the first information may be within a first system information block (SIB), the second information may be within a second SIB, and each SIB includes a respective public land mobile network (PLMN) identifier and a respective list of services associated with a respective network operator.

In some examples of the method, first network entities, and non-transitory computer-readable medium described herein, the first information further includes an identifier of the first network operator and the second information further includes an identifier of the second network operator.

Some examples of the method, first network entities, and non-transitory computer-readable medium described herein may further include operations, features, means, or instructions for transmitting an indication of the one or more first services to a second network entity associated with the first network operator and transmitting an indication of the one or more second services to a third network entity associated with the second network operator, where the second network entity and the third network entity may be higher-tier network entities relative to the first network entity.

Some examples of the method, first network entities, and non-transitory computer-readable medium described herein may further include operations, features, means, or instructions for transmitting, to the second network entity or the third network entity, an indication of an update to the first information or the second information based on a change in support of at least one service of the one or more first services or the one or more second services by the first network entity.

In some examples of the method, first network entities, and non-transitory computer-readable medium described herein, each of the second network entity and the third network entity may be a respective core network or central unit.

Some examples of the method, first network entities, and non-transitory computer-readable medium described herein may further include operations, features, means, or instructions for receiving an indication of a respective network operator identifier associated with the UE based on transmitting the first information and the second information and outputting a trigger message to a third network entity based on the respective network operator identifier being the same as a network operator associated with the third network entity, the trigger message associated with a synchronization signal block (SSB) or an SIB.

Some examples of the method, first network entities, and non-transitory computer-readable medium described herein may further include operations, features, means, or instructions for transmitting third information that indicates a set of multiple physical cell identifiers associated with the same network operator that may be associated with the UE.

Some examples of the method, first network entities, and non-transitory computer-readable medium described herein may further include operations, features, means, or instructions for transmitting fourth information that indicates a set of multiple physical cell identifiers associated with a network operator different than the network operator associated with the UE.

Some examples of the method, first network entities, and non-transitory computer-readable medium described herein may further include operations, features, means, or instructions for connecting the UE to the first network entity, transmitting one or more paging messages, facilitating communications with a third network entity, and transmitting assistance information associated with the third network entity.

In some examples of the method, first network entities, and non-transitory computer-readable medium described herein, the assistance information includes synchronization raster points, frequency information, wake-up signaling configuration information, or any combination thereof.

In some examples of the method, first network entities, and non-transitory computer-readable medium described herein, the one or more second services may be a subset of the one or more first services.

In some examples of the method, first network entities, and non-transitory computer-readable medium described herein, the one or more second services may be based on a timer duration, one or more periodic time periods, or any combination thereof.

A method for wireless communications by a UE is described. The method may include receiving first information that indicates one or more first services supported by a first network entity, where the one or more first services are associated with a first network operator, receiving second information that indicates one or more second services supported by the first network entity, the one or more second services associated with a second network operator, and utilizing at least one service of the one or more first services or the one or more second services, where utilizing the at least one service is based on the UE being associated with the first network operator or the second network operator.

A UE for wireless communications is described. The UE may include one or more memories storing processor executable code, and one or more processors coupled with the one or more memories. The one or more processors may individually or collectively be operable to execute the code to cause the UE to receive first information that indicates one or more first services supported by a first network entity, where the one or more first services are associated with a first network operator, receive second information that indicates one or more second services supported by the first network entity, the one or more second services associated with a second network operator, and utilize at least one service of the one or more first services or the one or more second services, where utilizing the at least one service is based on the UE being associated with the first network operator or the second network operator.

Another UE for wireless communications is described. The UE may include means for receiving first information that indicates one or more first services supported by a first network entity, where the one or more first services are associated with a first network operator, means for receiving second information that indicates one or more second services supported by the first network entity, the one or more second services associated with a second network operator, and means for utilizing at least one service of the one or more first services or the one or more second services, where utilizing the at least one service is based on the UE being associated with the first network operator or the second network operator.

A non-transitory computer-readable medium storing code for wireless communications is described. The code may include instructions executable by one or more processors to receive first information that indicates one or more first services supported by a first network entity, where the one or more first services are associated with a first network operator, receive second information that indicates one or more second services supported by the first network entity, the one or more second services associated with a second network operator, and utilize at least one service of the one or more first services or the one or more second services, where utilizing the at least one service is based on the UE being associated with the first network operator or the second network operator.

In some examples of the method, UEs, and non-transitory computer-readable medium described herein, receiving the first information and the second information may include operations, features, means, or instructions for receiving a first message including the first information and an indication that the second information may be in a second message, where utilizing the at least one service of the one or more first services may be based on the first message and receiving the second message including the second information.

In some examples of the method, UEs, and non-transitory computer-readable medium described herein, the first information may be within a first SIB, the second information may be within a second SIB, and each SIB includes a respective PLMN identifier and a respective list of services associated with a respective network operator.

In some examples of the method, UEs, and non-transitory computer-readable medium described herein, the first information further includes an identifier of the first network operator and the second information further includes an identifier of the second network operator.

Some examples of the method, UEs, and non-transitory computer-readable medium described herein may further include operations, features, means, or instructions for transmitting an indication of a respective network operator identifier associated with the UE based on receiving the first information and the second information and receiving third information from a third network entity based on transmitting the indication of the respective network operator identifier, where a network operator associated with the third network entity may be the same as the respective network operator identifier.

In some examples of the method, UEs, and non-transitory computer-readable medium described herein, the third information may be within an SSB or an SIB.

Some examples of the method, UEs, and non-transitory computer-readable medium described herein may further include operations, features, means, or instructions for receiving fourth information that indicates a set of multiple physical cell identifiers associated with the same network operator that may be associated with the UE.

Some examples of the method, UEs, and non-transitory computer-readable medium described herein may further include operations, features, means, or instructions for receiving fifth information that indicates a set of multiple physical cell identifiers associated with a different network operator than the network operator that may be associated with the UE.

Some examples of the method, UEs, and non-transitory computer-readable medium described herein may further include operations, features, means, or instructions for constructing a first list associated with the fourth information, constructing a second list associated with the fifth information, and communicating with a third network entity based on the first list, the second list, or both.

Some examples of the method, UEs, and non-transitory computer-readable medium described herein may further include operations, features, means, or instructions for refraining from utilizing the at least one service of the one or more first services or the one or more second services based on the UE being associated with a third network operator and performing a reselection process based on refraining from utilizing the at least one service.

Some examples of the method, UEs, and non-transitory computer-readable medium described herein may further include operations, features, means, or instructions for receiving an indication of a set of multiple physical cell identifiers associated with one or more network operators different than the third network operator and constructing a list based on the indication, where performing the reselection process may be based on the list.

Some examples of the method, UEs, and non-transitory computer-readable medium described herein may further include operations, features, means, or instructions for receiving, via a radio resource control message, an indication of information associated with a fourth network operator, the fourth network operator different than the network operator associated with the UE and transmitting the information to a second UE based on the second UE being associated with the fourth network operator.

Some examples of the method, UEs, and non-transitory computer-readable medium described herein may further include operations, features, means, or instructions for connecting to the first network entity, receiving one or more paging messages, communicating with a third network entity, and receiving assistance information associated with the third network entity.

In some examples of the method, UEs, and non-transitory computer-readable medium described herein, the assistance information includes synchronization raster points, frequency information, wake-up signaling configuration information, or any combination thereof.

In some examples of the method, UEs, and non-transitory computer-readable medium described herein, the one or more second services may be a subset of the one or more first services.

In some examples of the method, UEs, and non-transitory computer-readable medium described herein, the one or more second services may be based on a timer duration, one or more periodic time periods, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports cell sharing for enhanced user equipment (UE) connection in accordance with one or more aspects of the present disclosure.

FIG. 2 shows an example of a network architecture that supports cell sharing for enhanced UE connection in accordance with one or more aspects of the present disclosure.

FIGS. 3 and 4 show examples of wireless communications systems that support cell sharing for enhanced UE connection in accordance with one or more aspects of the present disclosure.

FIG. 5 shows an example of a process flow that supports cell sharing for enhanced UE connection in accordance with one or more aspects of the present disclosure.

FIGS. 6 and 7 show block diagrams of devices that support cell sharing for enhanced UE connection in accordance with one or more aspects of the present disclosure.

FIG. 8 shows a block diagram of a communications manager that supports cell sharing for enhanced UE connection in accordance with one or more aspects of the present disclosure.

FIG. 9 shows a diagram of a system including a device that supports cell sharing for enhanced UE connection in accordance with one or more aspects of the present disclosure.

FIGS. 10 and 11 show block diagrams of devices that support cell sharing for enhanced UE connection in accordance with one or more aspects of the present disclosure.

FIG. 12 shows a block diagram of a communications manager that supports cell sharing for enhanced UE connection in accordance with one or more aspects of the present disclosure.

FIG. 13 shows a diagram of a system including a device that supports cell sharing for enhanced UE connection in accordance with one or more aspects of the present disclosure.

FIGS. 14 and 15 show flowcharts illustrating methods that support cell sharing for enhanced UE connection in accordance with one or more aspects of the present disclosure.

### DETAILED DESCRIPTION

In some wireless communications systems, a first network entity (e.g., an assisting cell or anchor cell) may support network energy savings (NES) techniques at a second network entity (e.g., an NES network entity). In some examples, to perform the NES techniques, the first network entity and the second network entity may be associated with the same network operator (e.g., network provider). In such examples, a third network entity may not support the second network entity in performing NES techniques based on the third network entity being associated with a different network operator. When coverage areas for different network operators overlap, multiple assisting (e.g., anchor) network entities may be used. Thus, it may be desirable for different network operators to share an assisting network entity in overlapping coverage areas, rather than use a respective assisting network entity for each network operator.

The systems, methods, and techniques described herein may enable a shared network entity to provide services for multiple different network operators to a user equipment (UE). For example, the shared network entity may advertise a first list of services for a first network operator and a second list of services for a second operator to the UE. In some examples, the shared network entity may provide identifiers of each network operator in addition to the lists of supported services (e.g., in a system information block (SIB)). Additionally, or alternatively, the shared network entity may provide the second network operator information in a separate indication (e.g., in another SIB). In some cases, the shared network entity may transmit a list of network entity identifiers that share the same network operator as the UE and a list of network entity identifiers with a different network operator as the UE, which may enable the UE to construct an allow and block list of the network entities. In some examples, the shared network entity may inform higher-tier network entities (e.g., a core network (CN) or central unit (CU)) of the supported services for a respective network operator.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to cell sharing for enhanced UE connection.

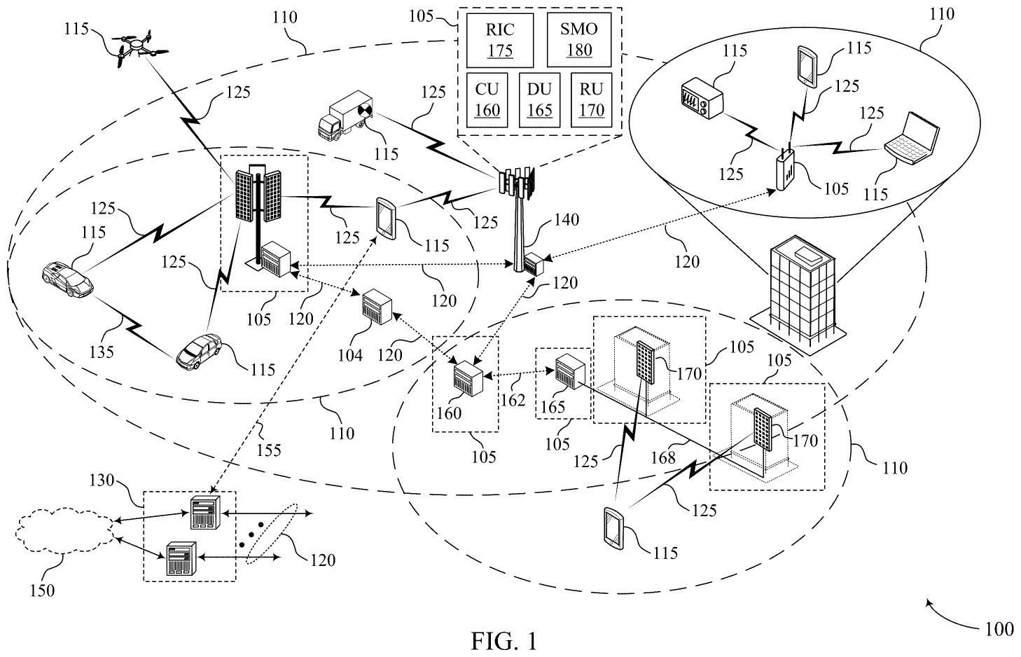

FIG. 1 shows an example of a wireless communications system 100 that supports cell sharing for enhanced UE connection in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some wireless communications systems 100, a first network entity 105 (e.g., an assisting cell or anchor cell) may support NES techniques at a second network entity 105 (e.g., an NES network entity). In some examples, to perform the NES techniques, the first network entity 105 and the second network entity 105 may be associated with the same network operator (e.g., network provider). In such examples, a third network entity 105 may not support the second network entity 105 in performing NES techniques based on the third network entity 105 being associated with a different network operator. When coverage areas for different network operators overlap, multiple assisting (e.g., anchor) network entities 105 may be used. Thus, it may be desirable for different network operators to share an assisting network entity 105 in overlapping coverage areas, rather than use a respective assisting network entity 105 for each network operator.

The systems, methods, and techniques described herein may enable a shared network entity 105 to provide services for multiple different network operators to a UE 115. For example, the shared network entity 105 may advertise a first list of services for a first network operator and a second list of services for a second operator to the UE 115. In some examples, the shared network entity 105 may provide identifiers of each network operator in addition to the lists of supported services (e.g., in a SIB). Additionally, or alternatively, the shared network entity 105 may provide the second network operator information in a separate indication (e.g., in another SIB). In some cases, the shared network entity 105 may transmit a list of network entity identifiers that share the same network operator as the UE 115 and a list of network entity identifiers with a different network operator as the UE 115, which may enable the UE 115 to construct an allow and block list of the network entities. In some examples, the shared network entity 105 may inform higher-tier network entities 105 (e.g., a core network 130 or a CU 160) of the supported services for a respective network operator.

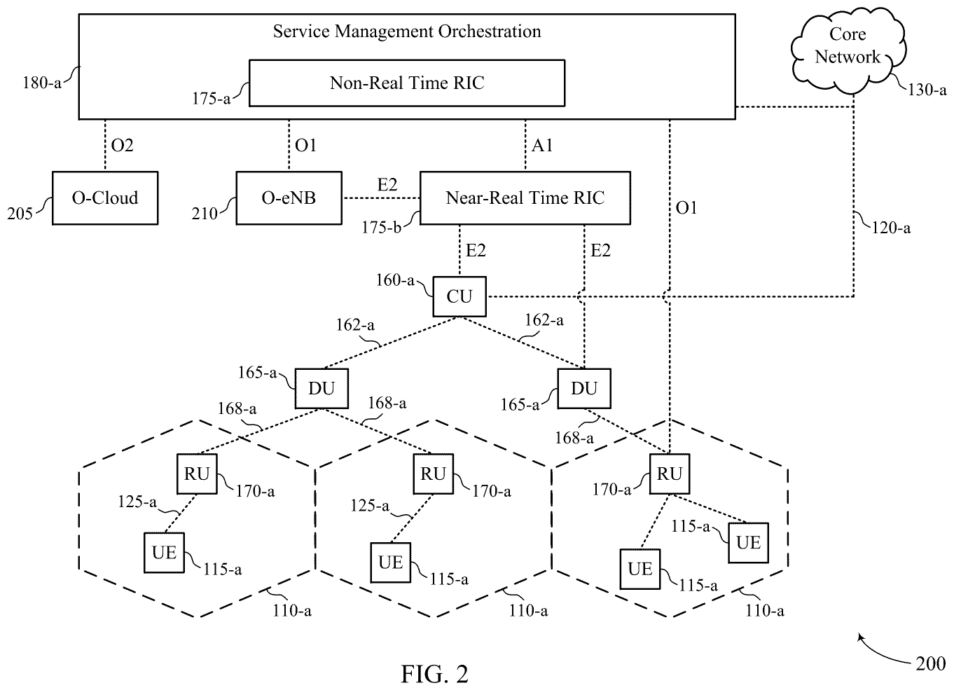

FIG. 2 shows an example of a network architecture 200 (e.g., a disaggregated base station architecture, a disaggregated RAN architecture) that supports cell sharing for enhanced UE connection in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

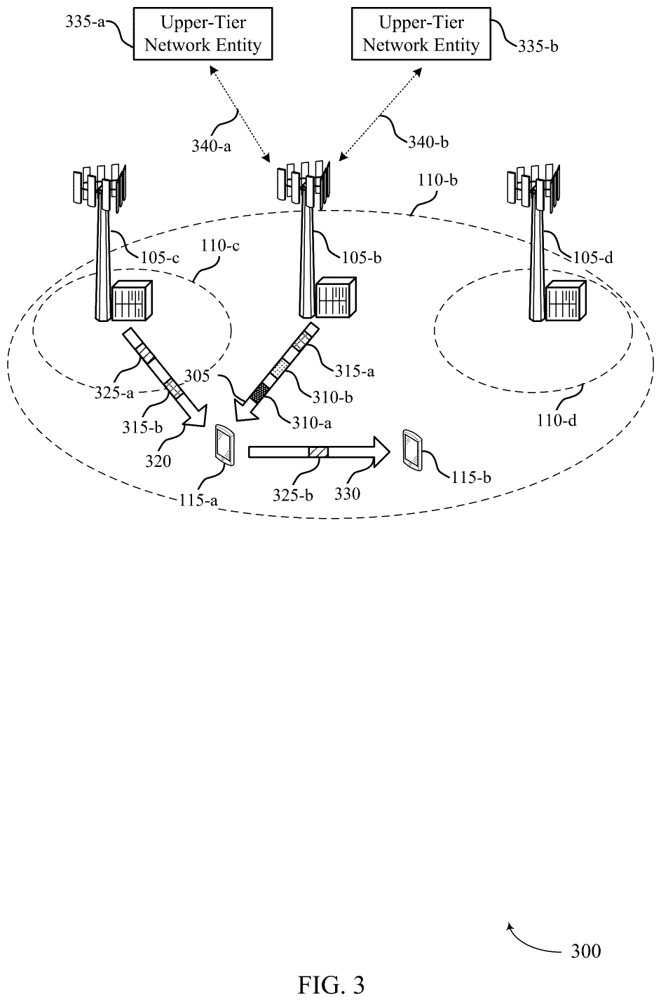

FIG. 3 shows an example of a wireless communications system 300 that supports cell sharing for enhanced UE connection in accordance with one or more aspects of the present disclosure. The wireless communications system 300 may implement or be implemented by aspects of the wireless communications system 100 or the network architecture 200, as described with reference to FIGS. 1 and 2. For example, the wireless communications system 300 may include network entities 105 and UEs 115, which may be examples of the corresponding devices described herein, including with reference to FIGS. 1 and 2.

In some wireless communications systems, an assisting network entity 105 (e.g., an anchor cell) may enable NES techniques at another network entity 105 (e.g., an NES network entity). In some examples, the assisting network entity 105 may enable the NES techniques based on the assisting network entity 105 and the other network entity 105 being associated with the same network operator (e.g., network provider). In some cases, multiple NES network entities 105 with different network operators may coexist in the same location (e.g., in a same coverage area 110). In some cases, network entities 105 may not assist NES network entities 105 with different network operators, which may result in multiple assisting network entities 105 for each network operator in the same location. Thus, it may be desirable for an assisting network entity 105 to provide services (e.g., share services) for different operators (e.g., such that one shared network entity 105 may assist multiple NES network entities 105).

The systems, methods, and techniques described herein may support a shared network entity 105-b providing one or more services for different network operators. For example, the shared network entity 105-b may support one or more services for two or more network operators in a coverage area 110-b. For example, network entity 105-c may be an NES network entity for a first network operator in a coverage area 110-c and network entity 105-d may be an NES network entity for a second network operator in a coverage area 110-d. The shared network entity 105-b may support services for both the first network operator and the second network operator based on the coverage area 110-c and the coverage area 110-d overlapping (e.g., completely or partially) with the coverage area 110-b. Although two different network operators are described in the wireless communications system 300, the techniques described herein for a shared network entity 105-b may apply to three or more different network operators. For example, the shared network entity 105-b may support services for any quantity of network operators with coverage areas 110 overlapping with the coverage area 110-b of the shared network entity 105-b.

The shared network entity 105-b may indicate (e.g., advertise) the one or more supported services via one or more downlink transmissions 305. For example, the shared network entity 105-b may transmit first information 310-a associated with a first network operator and second information 310-b associated with a second network operator in the one or more downlink transmissions 305. In some examples, the first information may include a first list of services the shared network entity 105-b supports for the first network operator, and the second information may include a second list of services the shared network entity 105-b supports for the second network operator. Additionally, or alternatively, the first information 310-a and the second information 310-b may include an identifier of the first network operator and the second network operator, respectively.

In some cases, the second list of services may be a subset of the first list of services. For example, the shared network entity 105-b may support different services for the second operator at different times in a day. In some examples, the second list of services may include the currently supported services (e.g., based on the time of day). In other examples, the second list of services may include all possible services (e.g., regardless of the time of day), and the second information may include an indication of which services are available based on the time of day. For example, a receiving UE 115 (e.g., a UE 115-a) may determine which services are available based on the time of day and the list of all supported services.

In some examples, the shared network entity 105-b may transmit the first information 310-a and the second information 310-b in a first downlink message (e.g., in SIB1). In other examples, the shared network entity 105-b may transmit the first information 310-a and an indication of the second information 310-b in a first downlink message and the second information 310-b in a second downlink message. For example, the shared network entity 105-b may transmit the first information 310-a in SIB1 and indicate, in SIB1, an SIB where the second information 310-b may be found (e.g., a RAN-shared cell may ask UEs 115 that belong to the second network operator to decode SIB4 for the list of supported services). In some examples, a respective SIB may include a different list of services for different network operators. In such examples, the SIB may include a network identifier (e.g., an identifier for a public land mobile network (PLMN)) and its associated list of services. In either of the described examples, a UE 115 belonging to the second network operator may know that the shared network entity 105-b may provide the second information 310-b (e.g., even if the second information 310-b is transmitted separately from the first information 310-a).

In some examples, the UE 115-a may receive the first information 310-a, the second information 310-b, or both, via the one or more downlink transmissions 305. The UE 115-a may be associated with (e.g., subscribed to or include a subscriber identity module (SIM) that is subscribed to) the first network operator, the second network operator, or a third network operator not supported by the shared network entity 105-b.

Additionally, or alternatively, the UE 115-a may receive the first information 310-a, the second information 310-b, or both, via a vRAN (e.g., a cloud or server), a configuration, system information (e.g., SIB1 or other SIs) from the shared network entity 105-b or a network entity 105 the UE 115-a has previously connected to, one or more RRC messages (e.g., RRC release message, RRC configuration message, and the like), an NAS (e.g., from a core network 130), or any combination thereof. In some examples, the UE 115-a may receive the first information 310-a and the information 310-b based on a location of the UE 115-a. For example, the UE 115-a may receive the information via RRC messaging. Additionally, or alternatively, the UE 115-a may receive the information via an NAS specific to a registration area or a RAN-based notification area (RNA) of the UE 115-a.

If the UE 115-a is associated with the first network operator or the second network operator, the UE 115-a may receive one or more services 315. The one or more services 315 may include connecting to the shared network entity 105-b (e.g., camping on the shared network entity 105-b), receiving paging messages from the shared network entity 105-b, accessing the shared network entity 105-b, or any combination thereof. For example, the shared network entity 105-b may provide one or more services 315-a associated with connecting to the shared network entity 105-b or accessing the shared network entity 105-b.

In some examples, the shared network entity 105-b may provide the UE 115-a with a list of network entity identifiers (e.g., PCIs) of one or more first network entities 105 associated with the same network operator as the UE 115-a (e.g., the network entity 105-c). The shared network entity 105-b may also provide the UE 115-a with a list of network entity identifiers of one or more second network entities 105 not associated with the same network operator as the UE 115-a (e.g., the network entity 105-d). Based on receiving the list of network entity identifiers, the UE 115-a may construct an allow and block list of the first network entities 105 and the second network entities 105, respectively. The allow and block list may enable an increase in connection speed of the UE 115-a. For example, the UE 115-a may attempt to connect to network entities 105 associated with the same network operator and not attempt to connect to network entities 105 associated with a different network operator, which may reduce time spent attempting to connect to network entities 105 associated with different network operators.

Additionally, or alternatively, the one or more services 315 may include the UE 115-a receiving assistance information for neighboring network entities 105 (e.g., that are associated with the same network operator). For example, the UE 115-a may be associated with (e.g., subscribed to) the first network operator. In some cases, the UE 115-a may receive assistance information, such as synchronization raster point information, frequency information, uplink wake-up signaling (e.g., UL-WUS) configuration information, or any combination thereof. In such cases, the UE 115-a may utilize the assistance information to receive one or more services 315-b from the network entity 105-c via one or more downlink transmissions 320.

The list of the one or more supported services described herein is exemplary and non-exclusive. For example, the supported services may include any service a network entity 105 may provide to a UE 115 or other network entity 105. For example, the one or more services may include any service related to transmitting information about one or more network operators, information about neighboring network entities (e.g., network entity 105-c and network entity 105-d), facilitating communications with the neighboring network entities, communicating with the shared network entity 105-b, and the like.

If the UE 115-a is associated with the third network operator (e.g., not supported by the shared network entity 105-b), the UE 115-a may not attempt to connect to the shared network entity 105-b. For example, the UE 115-a may perform a reselection process to select a different network entity 105 (e.g., a network entity 105 other than the shared network entity 105-b). In some examples, the shared network entity 105-b may indicate (e.g., in SIB1) a list of information associated with other network entities 105 associated with the same network operators as the network operators supported by the shared network entity 105-b. The list of information may include a list of network entity identifiers (e.g., PCI) and frequency information (e.g., frequency ranges) of the other network entities 105. In such examples, the UE 115-a may receive (e.g., decode) and use the list of information to construct a block list. For example, the block list may enable the UE 115-a to perform the reselection process more efficiently (e.g., the UE 115-a may not attempt to select network entities 105 in the block list).

In some examples, the UE 115-a may connect to a network entity 105 associated with a same network operator as the UE 115-a, such as the network entity 105-c. In such examples, the UE 115-a may receive third information 325-a associated with the second network operator via one or more downlink transmissions 320 from the network entity 105-c. For example, the UE 115-a may be RRC-connected to the network entity 105-c and receive the third information 325-a via dedicated RRC messages.

The UE 115-a may share the third information 325-a with a UE 115-b associated with the second network operator (e.g., via a sidelink transmission 330). For example, the UE 115-a may receive an indication that the UE 115-b is associated with (e.g., subscribed to) the second network operator and forward the third information 325-a, or a portion of the third information 325-b, to the UE 115-b. Additionally, or alternatively, the UE 115-a may be associated with both the first network operator and the second network operator (e.g., based on the UE 115-a including multiple SIMs subscribed to the first network operator and the second network operator). In such cases, a first SIM associated with the first network operator of the UE 115-a may share the third information 325-b with a second SIM associated with the second network operator of the UE 115-a.

In some examples, the shared network entity 105-b may inform an upper-tier network entity 335 of each network operator which services are supported for each network operator. For example, the shared network entity 105-b may transmit an indication of the first information 310-a to an upper-tier network entity 335-a via a communication link 340-a, and the shared network entity 105-b may transmit an indication of the second information 310-b to an upper-tier network entity 335-b via a communication link 340-b.

The communication links 340 may be backhaul links (e.g., a backhaul communication link 120), midhaul links (a midhaul communication link 162), or fronthaul links (e.g., a fronthaul communication link 168). The upper-tier network entities 335 may be upper-tier network entities relative to the shared network entity 105-b. For example, the upper-tier network entities may be a core network (e.g., based on the shared network entity 105-b being a gNB) or a CU (e.g., based on the shared network entity 105-b being a DU).

The shared network entity 105-b may transmit updated information to each upper-tier network entity 335. In some examples, the services supported by the shared network entity 105-b may change (e.g., a subset of the supported services for the second network operator may discontinue during a period of the day), and the shared network entity 105-b may transmit updated information indicating the change in supported services. For example, the shared network entity 105-b may perform paging at some times during the day and discontinue the paging at other times. The shared network entity 105-b may indicate whether paging is continued or resumed to the upper-tier network entity 335 associated with the same network operator as the paging.

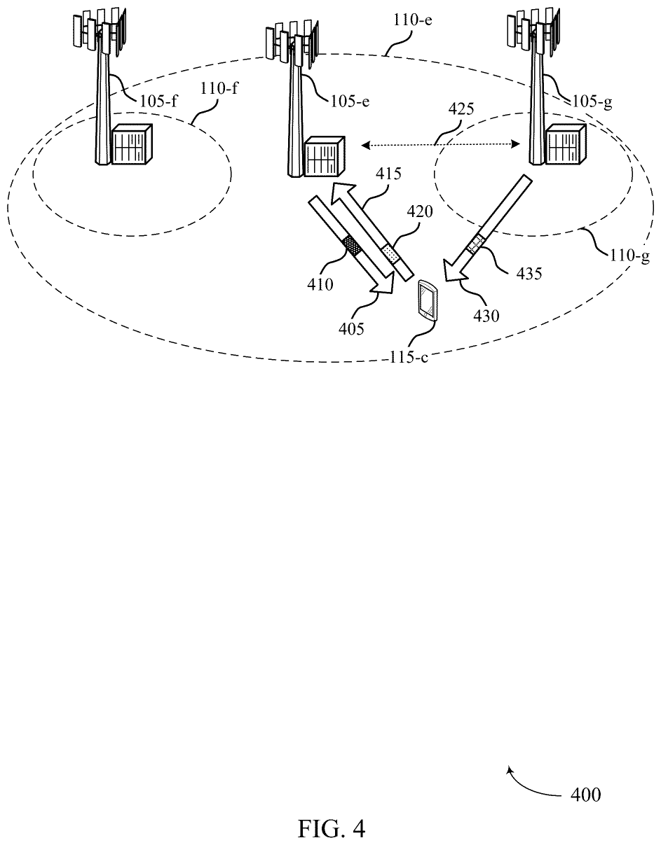

FIG. 4 shows an example of a wireless communications system 400 that supports cell sharing for enhanced UE connection in accordance with one or more aspects of the present disclosure. The wireless communications system 400 may implement or be implemented by aspects of the wireless communications system 100 and 300, as described with reference to FIGS. 1 and 3. For example, the wireless communications system may include network entities 105 and a UE 115-c, which may be examples of the corresponding devices described herein, including with reference to FIGS. 1 and 3.

The wireless communications system 400 may include a shared network entity 105-e that supports one or more services for two or more network operators in a coverage area 110-e. For example, network entity 105-f may be an NES network entity for a first network operator in a coverage area 110-f, and network entity 105-g may be an NES network entity for a second network operator in a coverage area 110-g. The shared network entity 105-e may support services for both the first network operator and the second network operator based on the coverage area 110-f and the coverage area 110-g overlapping (e.g., completely or partially) with the coverage area 110-c.

In some examples, the network entity 105-f and the network entity 105-g may be on-demand (OD) network entities 105. For example, the network entity 105-f and the network entity 105-g may provide, or increase, (e.g., transmit) synchronization signal block (SSB) messaging, SIB messaging, or both, in response to a trigger (e.g., a demand). For example, the shared network entity 105-e may output a trigger message to the network entity 105-g to transmit an SSB, an SIB, or both.

In some examples, the shared network entity 105-e may transmit a first indication 410 of one or more network operators supported by the shared network entity 105-c in a downlink transmission 405. The UE 115-c may transmit a second indication 420 of a network operator (e.g., the second network operator) associated with the UE 115-c in an uplink transmission 415 based on receiving the first indication 410. If the second indication 420 of the network operator is the same as the network operator associated with the network entity 105-g, the shared network entity 105-e may output the trigger message to the network entity 105-g via a communication link 425. The communication link 425 may be a backhaul link (e.g., a backhaul communication link 120), a midhaul link (a midhaul communication link 162), or a fronthaul link (e.g., a fronthaul communication link 168).

The network entity 105-g may transmit information 430 (e.g., SIB or SSB) via one or more downlink transmissions 435 based on obtaining the trigger message. Additionally, or alternatively, the network entity 105-g may output the information 430 more frequently based on obtaining the trigger message.

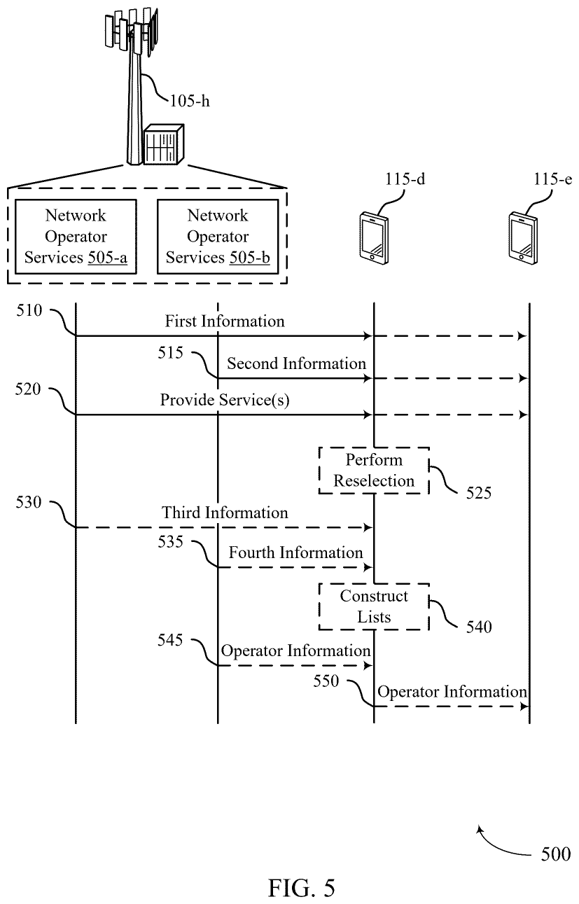

FIG. 5 shows an example of a process flow 500 that supports cell sharing for enhanced UE connection in accordance with one or more aspects of the present disclosure. The process flow 500 may be implemented by aspects of the wireless communications systems 100, 300, and 400. For example, a network entity 105-h and UEs 115, which may be examples of a UE 115 or a network entity 105 as described herein, may perform aspects of the process flow 500. In the following description of the process flow 500, operations performed by the UE 115-d, the UE 115-e, and the network entity 105-h may be performed in a different order than is shown. Some operations may be omitted from the process flow 500, and other operations may be added to the process flow 500. Further, although some operations or signaling may be shown to occur at different times for discussion purposes, these operations may occur at the same time.

The network entity 105-h may be a shared network entity that supports network operator services 505-a associated with a first network operator and network operator services 505-b associated with a second network operator. The UE 115-d and the UE 115-e may each be associated with (e.g., subscribed to) the first network operator, the second network operator, or a third network operator (e.g., a network operator different than the first and second network operators). In some examples, the UE 115-e is associated with a different network operator than the UE 115-d.

At 510, the shared network entity 105-h may transmit first information that indicates one or more first services supported by the shared network entity 105-h. The one or more first services may be associated with the network operator services 505-a (e.g., the first network operator). The UE 115-d, the UE 115-e, or both may receive the first information.

At 515, the shared network entity 105-h may transmit second information that indicates one or more second services supported by the shared network entity 105-h. The one or more second services may be associated with the network operator services 505-b (e.g., the second network operator). The UE 115-d, the UE 115-e, or both may receive the second information.

In some examples, the one or more first services, the one or more second services, or both, may include any combination of: connecting the UE 115-d (e.g., or the UE 115-e) to the shared network entity 105-h, transmitting one or more paging messages to the UE 115-d (e.g., or the UE 115-e), facilitating communications with another network entity 105, or transmitting assistance information associated with another network entity 105. The assistance information may include synchronization raster points, frequency information, wake-up signaling configuration information, or any combination thereof. In some examples, the one or more second services may be a subset of the one or more first services. For example, the one or more second services may be based on a timer duration or one or more periodic time periods (e.g., the second services may change based on a time of day or expiration of a timer).

At 520, the shared network entity 105-h may provide at least one service of the one or more first services or the one or more second services to the UE 115-d or the UE 115-e. For example, the shared network entity 105-h may provide at least one service of the one or more first services to the UE 115-d based on the UE 115-d being associated with the first network operator. The shared network entity 105-h may provide at least one of the one or more second services to the UE 115-e based on the UE 115-e being associated with the second network operator.

In some examples, the shared network entity 105-h may transmit a first message including the first information and an indication that the second information is in a second message. In such examples, the shared network entity 105-h may transmit a second message including the second information. For example, the UE 115-d may receive the first message and receive the at least one service of the one or more first services based on receiving the first message. The UE 115-e may receive the second message and the at least one service of the one or more second services based on the indication in the first message.

In some examples, the shared network entity 105-h may transmit the first information within a first SIB and the shared network entity 105-h may transmit the second information within a second SIB. In such examples, each SIB may include a respective PLMN identifier and a respective list of services associated with a respective network operator. Additionally, or alternatively, the first information may include an identifier of the first network operator and the second information may include an identifier of the second network operator.

At 525, the UE 115-d may perform a reselection process based on refraining from using one of the services supported by the network entity 105-h. For example, the UE 115-d may be associated with the third network operator, and thus refrain from utilizing a service of the one or more first services or the one or more second services. The UE 115-d may perform the reselection process to select a different network entity 105 (e.g., a network entity 105 associated with the third network operator).

In some examples, at 530, the UE 115-d may receive third information. In some examples, the third information may include an indication of PCIs associated with the same network operator that is associated with the UE 115-d.

At 535, the UE 115-d may receive fourth information that indicates multiple PCIs associated with a different network operator than the network operator associated with the UE 115-d. For example, if the UE 115-d is associated with the third network operator, the fourth information may include an indication of a list of PCIs associated with the first network operator, the second network operator, or both.

At 540, the UE 115-d may construct a first list (e.g., an allow list) based on the third information. For example, the UE 115-d may communicate (e.g., attempt to connect) with network entities 105 associated with the PCIs associated with the same network operator. Additionally, or alternatively, the UE 115-d may construct a second list (e.g., a block list) based on the fourth information. For example, the UE 115-d may not attempt to communicate or connect with the network entities 105 listed in the fourth information.

In some examples, at 545, the UE 115-d may receive an indication of operator information associated with a fourth network operator (e.g., a network operator different than the network operator associated with the UE 115-d). In some cases, the UE 115-d may receive the indication of information via an RRC message. At 550, the UE 115-d may transmit the operator information to the UE 115-e based on the UE 115-e being associated with the fourth network operator.

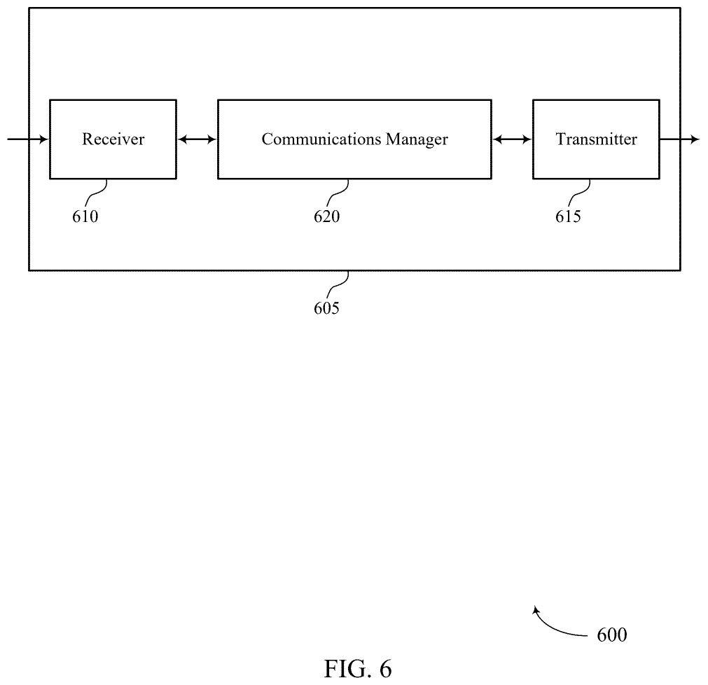

FIG. 6 shows a block diagram 600 of a device 605 that supports cell sharing for enhanced UE connection in accordance with one or more aspects of the present disclosure. The device 605 may be an example of aspects of a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations or components thereof may be examples of means for performing various aspects of cell sharing for enhanced UE connection as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting first information that indicates one or more first services supported by the first network entity, where the one or more first services are associated with a first network operator. The communications manager 620 is capable of, configured to, or operable to support a means for transmitting second information that indicates one or more second services supported by the first network entity, where the one or more second services are associated with a second network operator. The communications manager 620 is capable of, configured to, or operable to support a means for providing at least one service of the one or more first services or the one or more second services to a UE, where provision of the at least one service is based on the UE being associated with the first network operator or the second network operator.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources, among other examples.

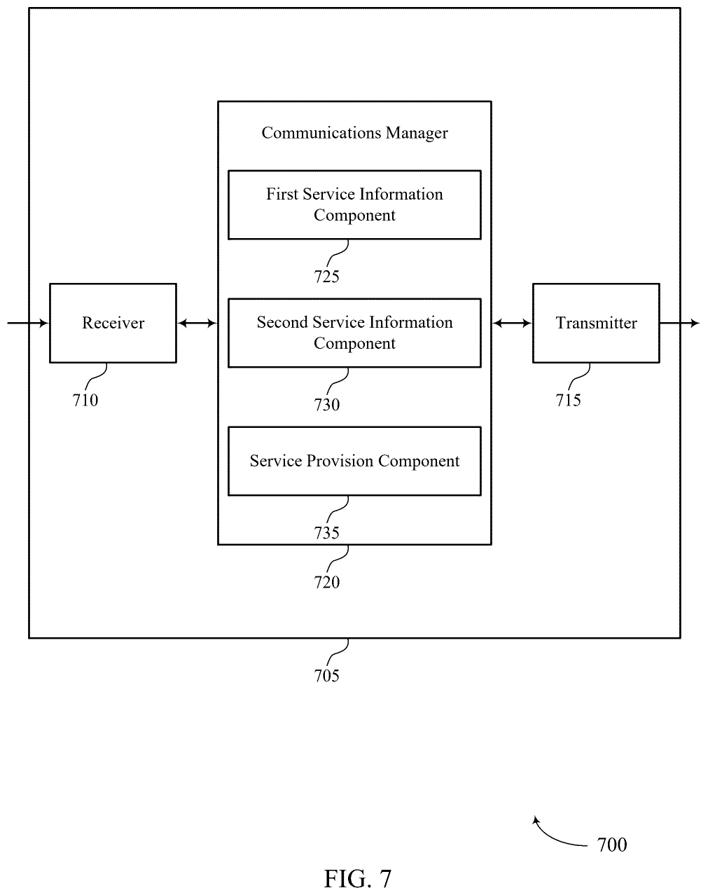

FIG. 7 shows a block diagram 700 of a device 705 that supports cell sharing for enhanced UE connection in accordance with one or more aspects of the present disclosure. The device 705 may be an example of aspects of a device 605 or a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of cell sharing for enhanced UE connection as described herein. For example, the communications manager 720 may include a first service information component 725, a second service information component 730, a service provision component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The first service information component 725 is capable of, configured to, or operable to support a means for transmitting first information that indicates one or more first services supported by the first network entity, where the one or more first services are associated with a first network operator. The second service information component 730 is capable of, configured to, or operable to support a means for transmitting second information that indicates one or more second services supported by the first network entity, where the one or more second services are associated with a second network operator. The service provision component 735 is capable of, configured to, or operable to support a means for providing at least one service of the one or more first services or the one or more second services to a UE, where provision of the at least one service is based on the UE being associated with the first network operator or the second network operator.

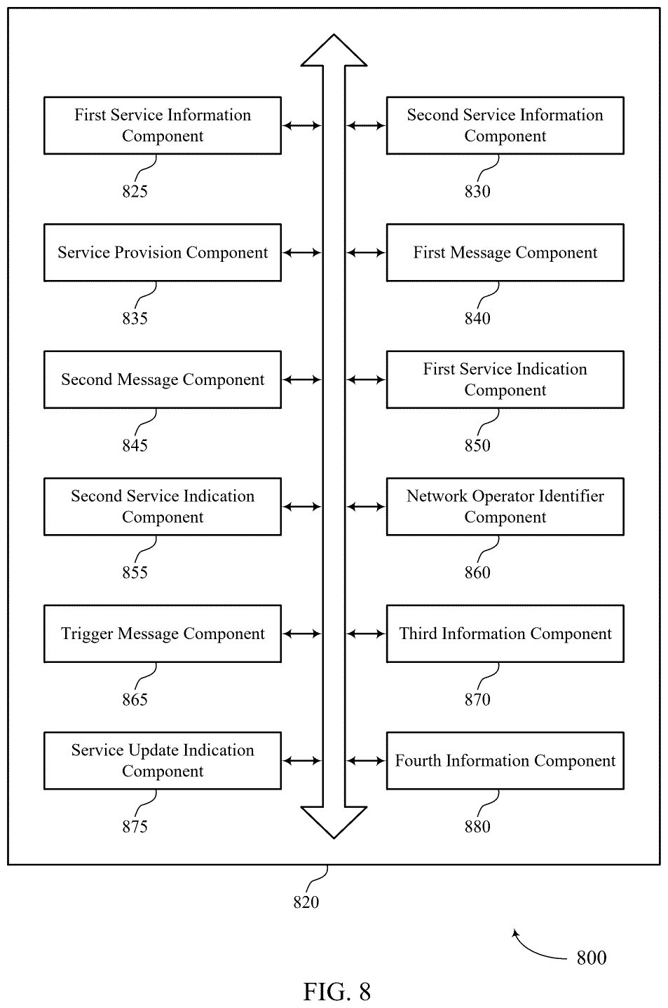

FIG. 8 shows a block diagram 800 of a communications manager 820 that supports cell sharing for enhanced UE connection in accordance with one or more aspects of the present disclosure. The communications manager 820 may be an example of aspects of a communications manager 620, a communications manager 720, or both, as described herein. The communications manager 820, or various components thereof, may be an example of means for performing various aspects of cell sharing for enhanced UE connection as described herein. For example, the communications manager 820 may include a first service information component 825, a second service information component 830, a service provision component 835, a first message component 840, a second message component 845, a first service indication component 850, a second service indication component 855, a network operator identifier component 860, a trigger message component 865, a third information component 870, a service update indication component 875, a fourth information component 880, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The first service information component 825 is capable of, configured to, or operable to support a means for transmitting first information that indicates one or more first services supported by the first network entity, where the one or more first services are associated with a first network operator. The second service information component 830 is capable of, configured to, or operable to support a means for transmitting second information that indicates one or more second services supported by the first network entity, where the one or more second services are associated with a second network operator. The service provision component 835 is capable of, configured to, or operable to support a means for providing at least one service of the one or more first services or the one or more second services to a UE, where provision of the at least one service is based on the UE being associated with the first network operator or the second network operator.

In some examples, to support transmitting the first information and transmitting the second information, the first message component 840 is capable of, configured to, or operable to support a means for transmitting a first message including the first information and an indication that the second information is in a second message, where provision of the at least one service of the one or more first services is based on the first message. In some examples, to support transmitting the first information and transmitting the second information, the second message component 845 is capable of, configured to, or operable to support a means for transmitting the second message including the second information.

In some examples, the first information is within a first system information block, the second information is within a second system information block, and each system information block includes a respective public land mobile network identifier and a respective list of services associated with a respective network operator.

In some examples, the first information further includes an identifier of the first network operator and the second information further includes an identifier of the second network operator.

In some examples, the first service indication component 850 is capable of, configured to, or operable to support a means for transmitting an indication of the one or more first services to a second network entity associated with the first network operator. In some examples, the second service indication component 855 is capable of, configured to, or operable to support a means for transmitting an indication of the one or more second services to a third network entity associated with the second network operator, where the second network entity and the third network entity are higher-tier network entities relative to the first network entity.

In some examples, the service update indication component 875 is capable of, configured to, or operable to support a means for transmitting, to the second network entity or the third network entity, an indication of an update to the first information or the second information based on a change in support of at least one service of the one or more first services or the one or more second services by the first network entity. In some examples, each of the second network entity and the third network entity is a respective core network or central unit.

In some examples, the network operator identifier component 860 is capable of, configured to, or operable to support a means for receiving an indication of a respective network operator identifier associated with the UE based on transmitting the first information and the second information. In some examples, the trigger message component 865 is capable of, configured to, or operable to support a means for outputting a trigger message to a third network entity based on the respective network operator identifier being the same as a network operator associated with the third network entity, the trigger message associated with a SSB or a SIB.

In some examples, the third information component 870 is capable of, configured to, or operable to support a means for transmitting third information that indicates a set of multiple physical cell identifiers associated with the same network operator that is associated with the UE.

In some examples, the fourth information component 880 is capable of, configured to, or operable to support a means for transmitting fourth information that indicates a set of multiple physical cell identifiers associated with a network operator different than the network operator associated with the UE.

In some examples, connecting the UE to the first network entity. In some examples, transmitting one or more paging messages. In some examples, facilitating communications with a third network entity. In some examples, transmitting assistance information associated with the third network entity. In some examples, the assistance information includes synchronization raster points, frequency information, wake-up signaling configuration information, or any combination thereof.

In some examples, the one or more second services are a subset of the one or more first services. In some examples, the one or more second services are based on a timer duration, one or more periodic time periods, or any combination thereof.

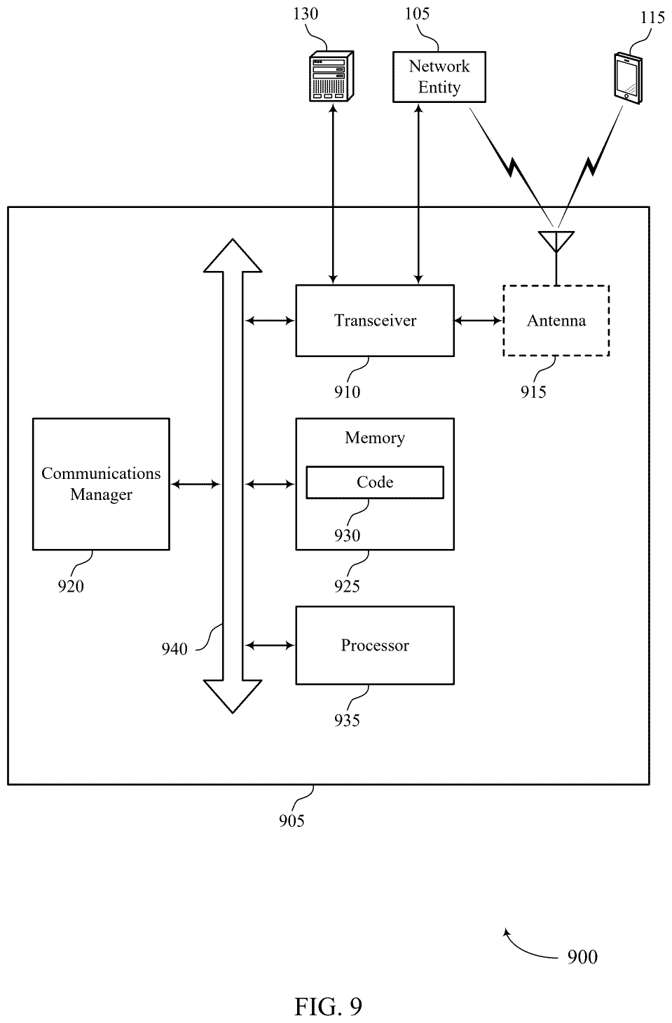

FIG. 9 shows a diagram of a system 900 including a device 905 that supports cell sharing for enhanced UE connection in accordance with one or more aspects of the present disclosure. The device 905 may be an example of or include components of a device 605, a device 705, or a network entity 105 as described herein. The device 905 may communicate with other network devices or network equipment such as one or more of the network entities 105, UEs 115, or any combination thereof. The communications may include communications over one or more wired interfaces, over one or more wireless interfaces, or any combination thereof. The device 905 may include components that support outputting and obtaining communications, such as a communications manager 920, a transceiver 910, one or more antennas 915, at least one memory 925, code 930, and at least one processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., communication link(s) 125, backhaul communication link(s) 120, a midhaul communication link 162, a fronthaul communication link 168).

The at least one memory 925 may include RAM, ROM, or any combination thereof. The at least one memory 925 may store computer-readable, computer-executable, or processor-executable code, such as the code 930. The code 930 may include instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may include, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting cell sharing for enhanced UE connection). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925).

In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. For example, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with one or more other network entities 105, and may include a controller or scheduler for controlling communications with UEs 115 (e.g., in cooperation with the one or more other network devices). In some examples, the communications manager 920 may support an X2 interface within an LTE/LTE-A wireless communications network technology to provide communication between network entities 105.

The communications manager 920 may support wireless communications in accordance with examples as disclosed herein. For example, the communications manager 920 is capable of, configured to, or operable to support a means for transmitting first information that indicates one or more first services supported by the first network entity, where the one or more first services are associated with a first network operator. The communications manager 920 is capable of, configured to, or operable to support a means for transmitting second information that indicates one or more second services supported by the first network entity, where the one or more second services are associated with a second network operator. The communications manager 920 is capable of, configured to, or operable to support a means for providing at least one service of the one or more first services or the one or more second services to a UE, where provision of the at least one service is based on the UE being associated with the first network operator or the second network operator.

By including or configuring the communications manager 920 in accordance with examples as described herein, the device 905 may support techniques for reduced latency, improved user experience related to reduced processing, reduced power consumption, more efficient utilization of communication resources, improved coordination between devices, longer battery life, and improved utilization of processing capability, among other examples.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of cell sharing for enhanced UE connection as described herein, or the at least one processor 935 and the at least one memory 925 may be otherwise configured to, individually or collectively, perform or support such operations.

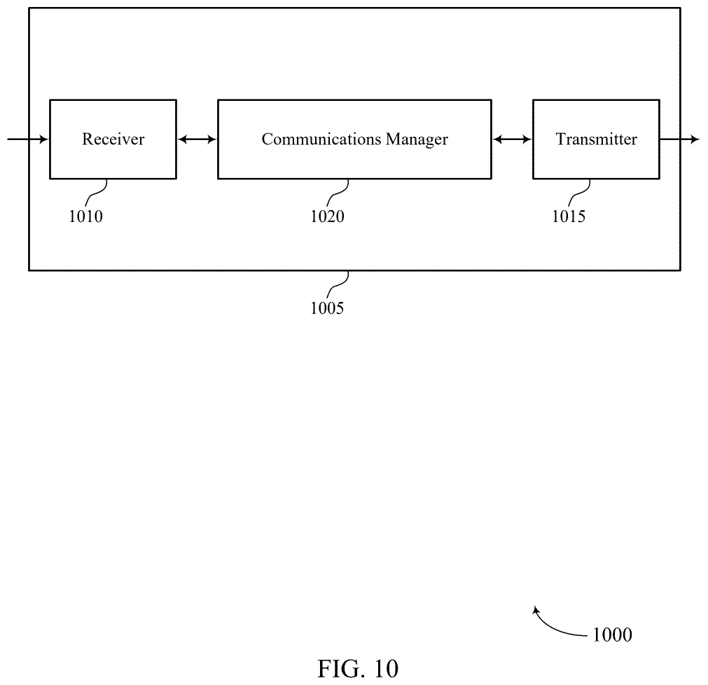

FIG. 10 shows a block diagram 1000 of a device 1005 that supports cell sharing for enhanced UE connection in accordance with one or more aspects of the present disclosure. The device 1005 may be an example of aspects of a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to cell sharing for enhanced UE connection). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to cell sharing for enhanced UE connection). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations or components thereof may be examples of means for performing various aspects of cell sharing for enhanced UE connection as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for receiving first information that indicates one or more first services supported by a first network entity, where the one or more first services are associated with a first network operator. The communications manager 1020 is capable of, configured to, or operable to support a means for receiving second information that indicates one or more second services supported by the first network entity, the one or more second services associated with a second network operator. The communications manager 1020 is capable of, configured to, or operable to support a means for utilizing at least one service of the one or more first services or the one or more second services, where utilizing the at least one service is based on the UE being associated with the first network operator or the second network operator.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources, among other examples.

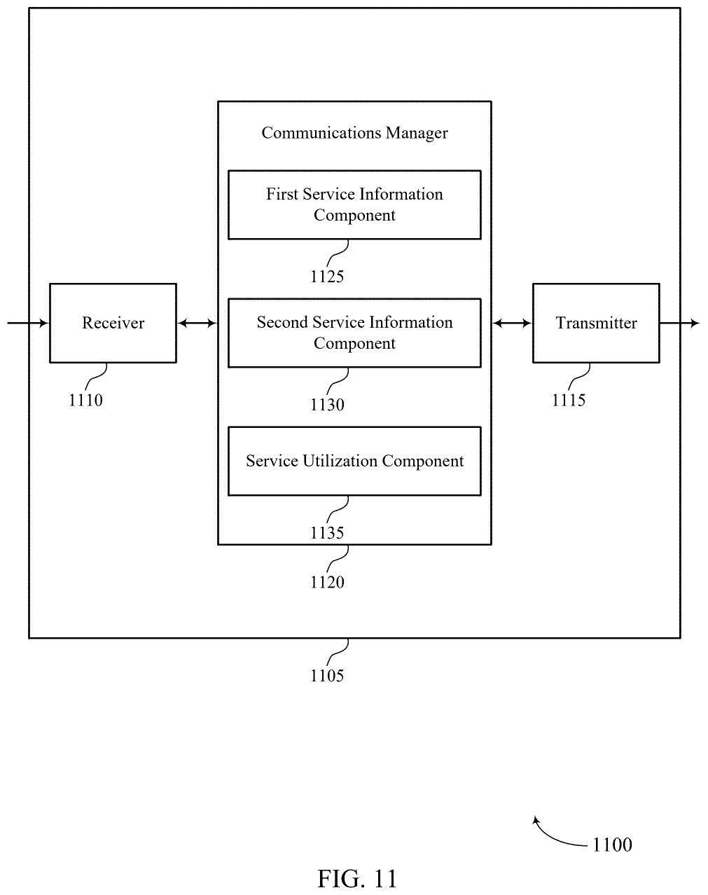

FIG. 11 shows a block diagram 1100 of a device 1105 that supports cell sharing for enhanced UE connection in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to cell sharing for enhanced UE connection). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to cell sharing for enhanced UE connection). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of cell sharing for enhanced UE connection as described herein. For example, the communications manager 1120 may include a first service information component 1125, a second service information component 1130, a service utilization component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The first service information component 1125 is capable of, configured to, or operable to support a means for receiving first information that indicates one or more first services supported by a first network entity, where the one or more first services are associated with a first network operator. The second service information component 1130 is capable of, configured to, or operable to support a means for receiving second information that indicates one or more second services supported by the first network entity, the one or more second services associated with a second network operator. The service utilization component 1135 is capable of, configured to, or operable to support a means for utilizing at least one service of the one or more first services or the one or more second services, where utilizing the at least one service is based on the UE being associated with the first network operator or the second network operator.

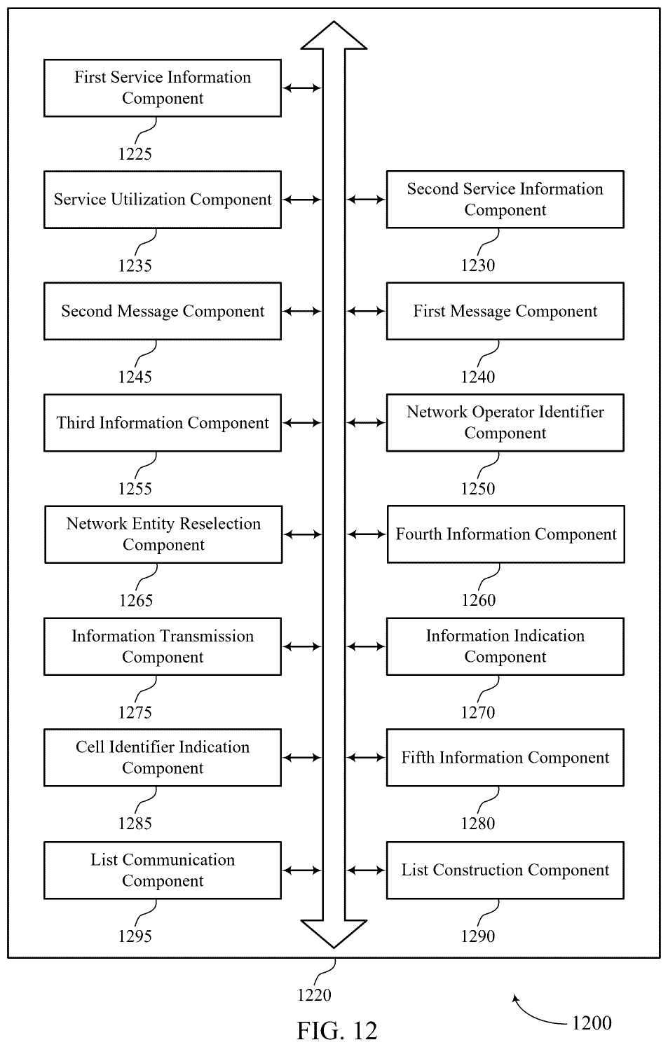

FIG. 12 shows a block diagram 1200 of a communications manager 1220 that supports cell sharing for enhanced UE connection in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of cell sharing for enhanced UE connection as described herein. For example, the communications manager 1220 may include a first service information component 1225, a second service information component 1230, a service utilization component 1235, a first message component 1240, a second message component 1245, a network operator identifier component 1250, a third information component 1255, a fourth information component 1260, a network entity reselection component 1265, an information indication component 1270, an information transmission component 1275, a fifth information component 1280, a cell identifier indication component 1285, a list construction component 1290, a list communication component 1295, or any combination thereof. Each of these components, or components or subcomponents thereof (e.g., one or more processors, one or more memories), may communicate, directly or indirectly, with one another (e.g., via one or more buses).

The communications manager 1220 may support wireless communications in accordance with examples as disclosed herein. The first service information component 1225 is capable of, configured to, or operable to support a means for receiving first information that indicates one or more first services supported by a first network entity, where the one or more first services are associated with a first network operator. The second service information component 1230 is capable of, configured to, or operable to support a means for receiving second information that indicates one or more second services supported by the first network entity, the one or more second services associated with a second network operator. The service utilization component 1235 is capable of, configured to, or operable to support a means for utilizing at least one service of the one or more first services or the one or more second services, where utilizing the at least one service is based on the UE being associated with the first network operator or the second network operator.

In some examples, to support receiving the first information and the second information, the first message component 1240 is capable of, configured to, or operable to support a means for receiving a first message including the first information and an indication that the second information is in a second message, where utilizing the at least one service of the one or more first services is based on the first message. In some examples, to support receiving the first information and the second information, the second message component 1245 is capable of, configured to, or operable to support a means for receiving the second message including the second information.

In some examples, the first information is within a first system information block, the second information is within a second system information block, and each system information block includes a respective public land mobile network identifier and a respective list of services associated with a respective network operator. In some examples, the first information further includes an identifier of the first network operator and the second information further includes an identifier of the second network operator.

In some examples, the network operator identifier component 1250 is capable of, configured to, or operable to support a means for transmitting an indication of a respective network operator identifier associated with the UE based on receiving the first information and the second information. In some examples, the third information component 1255 is capable of, configured to, or operable to support a means for receiving third information from a third network entity based on transmitting the indication of the respective network operator identifier, where a network operator associated with the third network entity is the same as the respective network operator identifier. In some examples, the third information is within a SSB or a SIB.

In some examples, the fourth information component 1260 is capable of, configured to, or operable to support a means for receiving fourth information that indicates a set of multiple physical cell identifiers associated with the same network operator that is associated with the UE.

In some examples, the fifth information component 1280 is capable of, configured to, or operable to support a means for receiving fifth information that indicates a set of multiple physical cell identifiers associated with a different network operator than the network operator that is associated with the UE.

In some examples, the list construction component 1290 is capable of, configured to, or operable to support a means for constructing a first list associated with the fourth information. In some examples, the list construction component 1290 is capable of, configured to, or operable to support a means for constructing a second list associated with the fifth information. In some examples, the list communication component 1295 is capable of, configured to, or operable to support a means for communicating with a third network entity based on the first list, the second list, or both.

In some examples, the service utilization component 1235 is capable of, configured to, or operable to support a means for refraining from utilizing the at least one service of the one or more first services or the one or more second services based on the UE being associated with a third network operator. In some examples, the network entity reselection component 1265 is capable of, configured to, or operable to support a means for performing a reselection process based on refraining from utilizing the at least one service.

In some examples, the cell identifier indication component 1285 is capable of, configured to, or operable to support a means for receiving an indication of a set of multiple physical cell identifiers associated with one or more network operators different than the third network operator. In some examples, the list construction component 1290 is capable of, configured to, or operable to support a means for constructing a list based on the indication, where performing the reselection process is based on the list.

In some examples, the information indication component 1270 is capable of, configured to, or operable to support a means for receiving, via a radio resource control message, an indication of information associated with a fourth network operator, the fourth network operator different than the network operator associated with the UE. In some examples, the information transmission component 1275 is capable of, configured to, or operable to support a means for transmitting the information to a second UE based on the second UE being associated with the fourth network operator.

In some examples, connecting to the first network entity. In some examples, receiving one or more paging messages. In some examples, communicating with a third network entity. In some examples, receiving assistance information associated with the third network entity. In some examples, the assistance information includes synchronization raster points, frequency information, wake-up signaling configuration information, or any combination thereof.

In some examples, the one or more second services are a subset of the one or more first services. In some examples, the one or more second services are based on a timer duration, one or more periodic time periods, or any combination thereof.

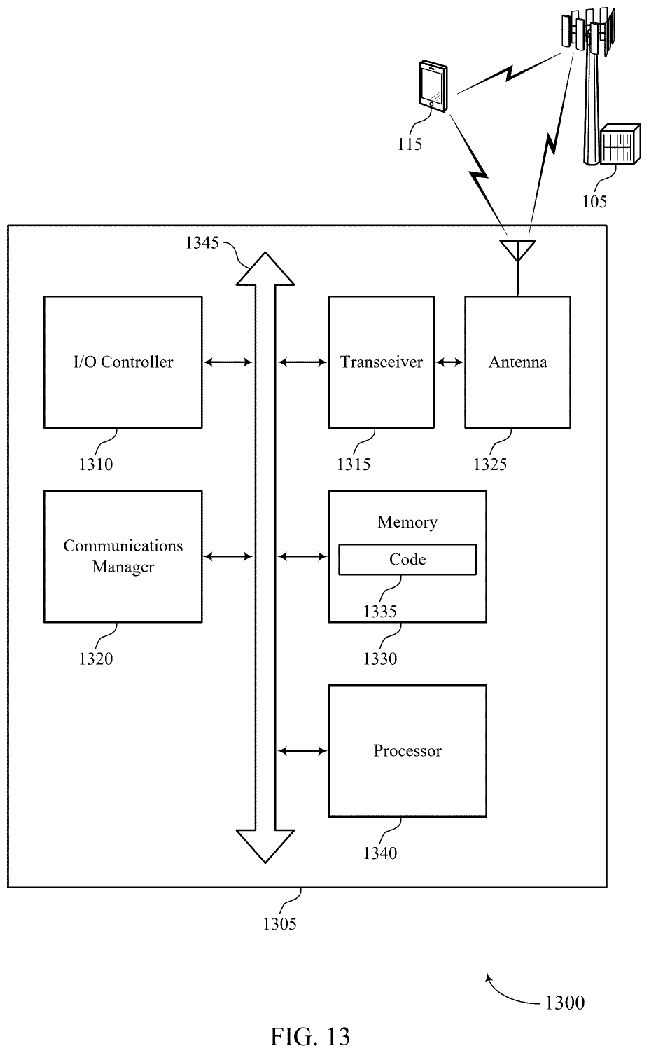

FIG. 13 shows a diagram of a system 1300 including a device 1305 that supports cell sharing for enhanced UE connection in accordance with one or more aspects of the present disclosure. The device 1305 may be an example of or include components of a device 1005, a device 1105, or a UE 115 as described herein. The device 1305 may communicate (e.g., wirelessly) with one or more other devices (e.g., network entities 105, UEs 115, or a combination thereof). The device 1305 may include components for bi-directional voice and data communications including components for transmitting and receiving communications, such as a communications manager 1320, an input/output (I/O) controller, such as an I/O controller 1310, a transceiver 1315, one or more antennas 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna. However, in some other cases, the device 1305 may have more than one antenna, which may be capable of concurrently transmitting or receiving multiple wireless transmissions. The transceiver 1315 may communicate bi-directionally via the one or more antennas 1325 using wired or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The at least one memory 1330 may include random access memory (RAM) and read-only memory (ROM). The at least one memory 1330 may store computer-readable, computer-executable, or processor-executable code, such as the code 1335. The code 1335 may include instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (e.g., when compiled and executed) to perform functions described herein. In some cases, the at least one memory 1330 may include, among other things, a basic I/O system (BIOS) which may control basic hardware or software operation such as the interaction with peripheral components or devices.

The at least one processor 1340 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (e.g., the at least one memory 1330) to cause the device 1305 to perform various functions (e.g., functions or tasks supporting cell sharing for enhanced UE connection). For example, the device 1305 or a component of the device 1305 may include at least one processor 1340 and at least one memory 1330 coupled with or to the at least one processor 1340, the at least one processor 1340 and the at least one memory 1330 configured to perform various functions described herein.

In some examples, the at least one processor 1340 may include multiple processors and the at least one memory 1330 may include multiple memories. One or more of the multiple processors may be coupled with one or more of the multiple memories, which may, individually or collectively, be configured to perform various functions described herein. In some examples, the at least one processor 1340 may be a component of a processing system, which may refer to a system (such as a series) of machines, circuitry (including, for example, one or both of processor circuitry (which may include the at least one processor 1340) and memory circuitry (which may include the at least one memory 1330)), or components, that receives or obtains inputs and processes the inputs to produce, generate, or obtain a set of outputs. The processing system may be configured to perform one or more of the functions described herein. For example, the at least one processor 1340 or a processing system including the at least one processor 1340 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code 1335 (e.g., processor-executable code) stored in the at least one memory 1330 or otherwise, to perform one or more of the functions described herein.

The communications manager 1320 may support wireless communications in accordance with examples as disclosed herein. For example, the communications manager 1320 is capable of, configured to, or operable to support a means for receiving first information that indicates one or more first services supported by a first network entity, where the one or more first services are associated with a first network operator. The communications manager 1320 is capable of, configured to, or operable to support a means for receiving second information that indicates one or more second services supported by the first network entity, the one or more second services associated with a second network operator. The communications manager 1320 is capable of, configured to, or operable to support a means for utilizing at least one service of the one or more first services or the one or more second services, where utilizing the at least one service is based on the UE being associated with the first network operator or the second network operator.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability, among other examples.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of cell sharing for enhanced UE connection as described herein, or the at least one processor 1340 and the at least one memory 1330 may be otherwise configured to, individually or collectively, perform or support such operations.

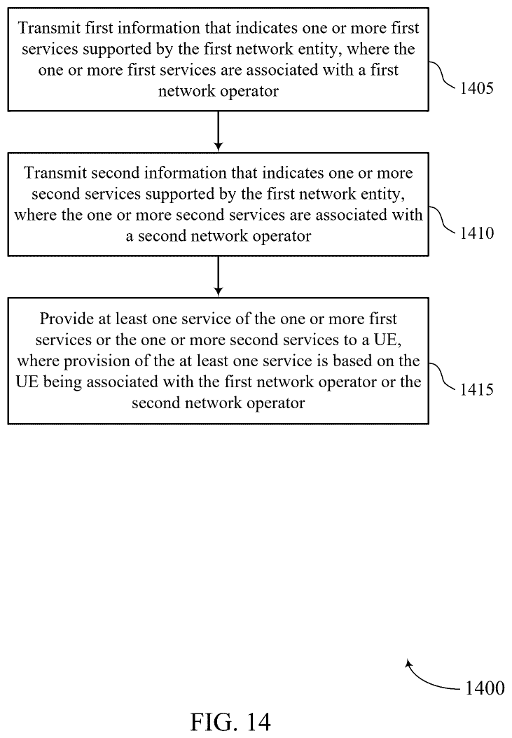

FIG. 14 shows a flowchart illustrating a method 1400 that supports cell sharing for enhanced UE connection in accordance with one or more aspects of the present disclosure. The operations of the method 1400 may be implemented by a network entity or its components as described herein. For example, the operations of the method 1400 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1405, the method may include transmitting first information that indicates one or more first services supported by the first network entity, where the one or more first services are associated with a first network operator. The operations of 1405 may be performed in accordance with examples as disclosed herein. In some examples, aspects of the operations of 1405 may be performed by a first service information component 825 as described with reference to FIG. 8.

At 1410, the method may include transmitting second information that indicates one or more second services supported by the first network entity, where the one or more second services are associated with a second network operator. The operations of 1410 may be performed in accordance with examples as disclosed herein. In some examples, aspects of the operations of 1410 may be performed by a second service information component 830 as described with reference to FIG. 8.

At 1415, the method may include providing at least one service of the one or more first services or the one or more second services to a UE, where provision of the at least one service is based on the UE being associated with the first network operator or the second network operator. The operations of 1415 may be performed in accordance with examples as disclosed herein. In some examples, aspects of the operations of 1415 may be performed by a service provision component 835 as described with reference to FIG. 8.

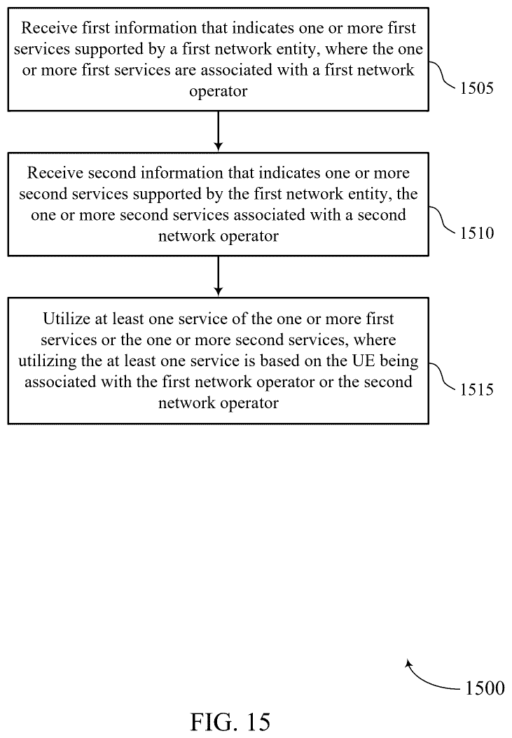

FIG. 15 shows a flowchart illustrating a method 1500 that supports cell sharing for enhanced UE connection in accordance with one or more aspects of the present disclosure. The operations of the method 1500 may be implemented by a UE or its components as described herein. For example, the operations of the method 1500 may be performed by a UE 115 as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1505, the method may include receiving first information that indicates one or more first services supported by a first network entity, where the one or more first services are associated with a first network operator. The operations of 1505 may be performed in accordance with examples as disclosed herein. In some examples, aspects of the operations of 1505 may be performed by a first service information component 1225 as described with reference to FIG. 12.

At 1510, the method may include receiving second information that indicates one or more second services supported by the first network entity, the one or more second services associated with a second network operator. The operations of 1510 may be performed in accordance with examples as disclosed herein. In some examples, aspects of the operations of 1510 may be performed by a second service information component 1230 as described with reference to FIG. 12.

At 1515, the method may include utilizing at least one service of the one or more first services or the one or more second services, where utilizing the at least one service is based on the UE being associated with the first network operator or the second network operator. The operations of 1515 may be performed in accordance with examples as disclosed herein. In some examples, aspects of the operations of 1515 may be performed by a service utilization component 1235 as described with reference to FIG. 12.

The following provides an overview of aspects of the present disclosure:

Aspect 1: A method for wireless communications at a first network entity, comprising: transmitting first information that indicates one or more first services supported by the first network entity, wherein the one or more first services are associated with a first network operator; transmitting second information that indicates one or more second services supported by the first network entity, wherein the one or more second services are associated with a second network operator; and providing at least one service of the one or more first services or the one or more second services to a UE, wherein provision of the at least one service is based at least in part on the UE being associated with the first network operator or the second network operator.

Aspect 2: The method of aspect 1, wherein transmitting the first information and transmitting the second information comprises: transmitting a first message comprising the first information and an indication that the second information is in a second message, wherein provision of the at least one service of the one or more first services is based at least in part on the first message; and transmitting the second message comprising the second information.

Aspect 3: The method of aspect 2, wherein the first information is within a first SIB, the second information is within a second SIB, and each SIB comprises a respective PLMN identifier and a respective list of services associated with a respective network operator.

Aspect 4: The method of any of aspects 1 through 3, wherein the first information further comprises an identifier of the first network operator and the second information further comprises an identifier of the second network operator.

Aspect 5: The method of any of aspects 1 through 4, further comprising: transmitting an indication of the one or more first services to a second network entity associated with the first network operator; and transmitting an indication of the one or more second services to a third network entity associated with the second network operator, wherein the second network entity and the third network entity are higher-tier network entities relative to the first network entity.

Aspect 6: The method of aspect 5, further comprising: transmitting, to the second network entity or the third network entity, an indication of an update to the first information or the second information based at least in part on a change in support of at least one service of the one or more first services or the one or more second services by the first network entity.

Aspect 7: The method of any of aspects 5 through 6, wherein each of the second network entity and the third network entity is a respective core network or central unit.

Aspect 8: The method of any of aspects 1 through 7, further comprising: receiving an indication of a respective network operator identifier associated with the UE based at least in part on transmitting the first information and the second information; and outputting a trigger message to a third network entity based at least in part on the respective network operator identifier being the same as a network operator associated with the third network entity, the trigger message associated with an SSB or an SIB.

Aspect 9: The method of any of aspects 1 through 8, further comprising: transmitting third information that indicates a plurality of physical cell identifiers associated with the same network operator that is associated with the UE.

Aspect 10: The method of aspect 9, further comprising: transmitting fourth information that indicates a plurality of physical cell identifiers associated with a network operator different than the network operator associated with the UE.

Aspect 11: The method of any of aspects 1 through 10, wherein the one or more first services, the one or more second services, or both, comprise any combination of connecting the UE to the first network entity; transmitting one or more paging messages; facilitating communications with a third network entity; or transmitting assistance information associated with the third network entity.

Aspect 12: The method of aspect 11, wherein the assistance information comprises synchronization raster points, frequency information, wake-up signaling configuration information, or any combination thereof.

Aspect 13: The method of any of aspects 1 through 12, wherein the one or more second services are a subset of the one or more first services.

Aspect 14: The method of aspect 13, wherein the one or more second services are based at least in part on a timer duration, one or more periodic time periods, or any combination thereof.

Aspect 15: A method for wireless communications at a UE, comprising: receiving first information that indicates one or more first services supported by a first network entity, wherein the one or more first services are associated with a first network operator; receiving second information that indicates one or more second services supported by the first network entity, the one or more second services associated with a second network operator; and utilizing at least one service of the one or more first services or the one or more second services, wherein utilizing the at least one service is based at least in part on the UE being associated with the first network operator or the second network operator.

Aspect 16: The method of aspect 15, wherein receiving the first information and the second information comprises: receiving a first message comprising the first information and an indication that the second information is in a second message, wherein utilizing the at least one service of the one or more first services is based at least in part on the first message; and receiving the second message comprising the second information.

Aspect 17: The method of aspect 16, wherein the first information is within a first SIB, the second information is within a second SIB, and each SIB comprises a respective PLMN identifier and a respective list of services associated with a respective network operator.

Aspect 18: The method of any of aspects 15 through 17, wherein the first information further comprises an identifier of the first network operator and the second information further comprises an identifier of the second network operator.

Aspect 19: The method of any of aspects 15 through 18, further comprising: transmitting an indication of a respective network operator identifier associated with the UE based at least in part on receiving the first information and the second information; and receiving third information from a third network entity based at least in part on transmitting the indication of the respective network operator identifier, wherein a network operator associated with the third network entity is the same as the respective network operator identifier.

Aspect 20: The method of aspect 19, wherein the third information is within an SSB or an SIB.

Aspect 21: The method of any of aspects 15 through 20, further comprising: receiving fourth information that indicates a plurality of physical cell identifiers associated with the same network operator that is associated with the UE.

Aspect 22: The method of aspect 21, further comprising: receiving fifth information that indicates a plurality of physical cell identifiers associated with a different network operator than the network operator that is associated with the UE.

Aspect 23: The method of aspect 22, further comprising: constructing a first list associated with the fourth information; constructing a second list associated with the fifth information; and communicating with a third network entity based at least in part on the first list, the second list, or both.

Aspect 24: The method of aspect 15, further comprising: refraining from utilizing the at least one service of the one or more first services or the one or more second services based at least in part on the UE being associated with a third network operator; and performing a reselection process based at least in part on refraining from utilizing the at least one service.

Aspect 25: The method of aspect 24, further comprising: receiving an indication of a plurality of physical cell identifiers associated with one or more network operators different than the third network operator; and constructing a list based at least in part on the indication, wherein performing the reselection process is based at least in part on the list.

Aspect 26: The method of any of aspects 15 through 25, further comprising: receiving, via an RRC message, an indication of information associated with a fourth network operator, the fourth network operator different than the network operator associated with the UE; and transmitting the information to a second UE based at least in part on the second UE being associated with the fourth network operator.

Aspect 27: The method of any of aspects 15 through 26, wherein the one or more first services, the one or more second services, or both, comprise any combination of connecting to the first network entity; receiving one or more paging messages; communicating with a third network entity; or receiving assistance information associated with the third network entity.

Aspect 28: The method of aspect 27, wherein the assistance information comprises synchronization raster points, frequency information, wake-up signaling configuration information, or any combination thereof.

Aspect 29: The method of any of aspects 15 through 28, wherein the one or more second services are a subset of the one or more first services.

Aspect 30: The method of aspect 29, wherein the one or more second services are based at least in part on a timer duration, one or more periodic time periods, or any combination thereof.

Aspect 31: A first network entity for wireless communications, comprising one or more memories storing processor-executable code, and one or more processors coupled with the one or more memories and individually or collectively operable to execute the code to cause the first network entity to perform a method of any of aspects 1 through 14.

Aspect 32: A first network entity for wireless communications, comprising at least one means for performing a method of any of aspects 1 through 14.

Aspect 33: A non-transitory computer-readable medium storing code for wireless communications, the code comprising instructions executable by one or more processors to perform a method of any of aspects 1 through 14.

Aspect 34: A UE for wireless communications, comprising one or more memories storing processor-executable code, and one or more processors coupled with the one or more memories and individually or collectively operable to execute the code to cause the UE to perform a method of any of aspects 15 through 30.

Aspect 35: A UE for wireless communications, comprising at least one means for performing a method of any of aspects 15 through 30.

Aspect 36: A non-transitory computer-readable medium storing code for wireless communications, the code comprising instructions executable by one or more processors to perform a method of any of aspects 15 through 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity, comprising:
one or more memories storing processor-executable code; and
one or more processors coupled with the one or more memories and individually or collectively operable to execute the code to cause the first network entity to:
transmit first information that indicates one or more first services supported by the first network entity, wherein the one or more first services are associated with a first network operator;
transmit second information that indicates one or more second services supported by the first network entity, wherein the one or more second services are associated with a second network operator; and
provide at least one service of the one or more first services or the one or more second services to a user equipment (UE), wherein provision of the at least one service is based at least in part on the UE being associated with the first network operator or the second network operator.

2. The first network entity of claim 1, wherein, to transmit the first information and transmitting the second information, the one or more processors are individually or collectively operable to execute the code to cause the first network entity to:
transmit a first message comprising the first information and an indication that the second information is in a second message, wherein provision of the at least one service of the one or more first services is based at least in part on the first message; and
transmit the second message comprising the second information.

3. The first network entity of claim 2, wherein the first information is within a first system information block, the second information is within a second system information block, and each system information block comprises a respective public land mobile network identifier and a respective list of services associated with a respective network operator.

4. The first network entity of claim 1, wherein the first information further comprises an identifier of the first network operator and the second information further comprises an identifier of the second network operator.

5. The first network entity of claim 1, wherein the one or more processors are individually or collectively further operable to execute the code to cause the first network entity to:
transmit an indication of the one or more first services to a second network entity associated with the first network operator; and
transmit an indication of the one or more second services to a third network entity associated with the second network operator, wherein the second network entity and the third network entity are higher-tier network entities relative to the first network entity.

6. The first network entity of claim 5, wherein the one or more processors are individually or collectively further operable to execute the code to cause the first network entity to:
transmit, to the second network entity or the third network entity, an indication of an update to the first information or the second information based at least in part on a change in support of at least one service of the one or more first services or the one or more second services by the first network entity.

7. The first network entity of claim 5, wherein each of the second network entity and the third network entity is a respective core network or central unit.

8. The first network entity of claim 1, wherein the one or more processors are individually or collectively further operable to execute the code to cause the first network entity to:
receive an indication of a respective network operator identifier associated with the UE based at least in part on transmitting the first information and the second information; and
output a trigger message to a third network entity based at least in part on the respective network operator identifier being the same as a network operator associated with the third network entity, the trigger message associated with a synchronization signal block or a system information block.

9. The first network entity of claim 1, wherein the one or more processors are individually or collectively further operable to execute the code to cause the first network entity to:
transmit third information that indicates a plurality of physical cell identifiers associated with the same network operator that is associated with the UE.

10. The first network entity of claim 9, wherein the one or more processors are individually or collectively further operable to execute the code to cause the first network entity to:
transmit fourth information that indicates a plurality of physical cell identifiers associated with a network operator different than the network operator associated with the UE.

11. The first network entity of claim 1, wherein:
connecting the UE to the first network entity;
transmitting one or more paging messages;
facilitating communications with a third network entity; or
transmitting assistance information associated with the third network entity.

12. The first network entity of claim 11, wherein the assistance information comprises synchronization raster points, frequency information, wake-up signaling configuration information, or any combination thereof.

13. The first network entity of claim 1, wherein the one or more second services are a subset of the one or more first services.

14. The first network entity of claim 13, wherein the one or more second services are based at least in part on a timer duration, one or more periodic time periods, or any combination thereof.

15. A method for wireless communications at a first network entity, comprising:
transmitting first information that indicates one or more first services supported by the first network entity, wherein the one or more first services are associated with a first network operator;
transmitting second information that indicates one or more second services supported by the first network entity, wherein the one or more second services are associated with a second network operator; and
providing at least one service of the one or more first services or the one or more second services to a user equipment (UE), wherein provision of the at least one service is based at least in part on the UE being associated with the first network operator or the second network operator.

16. The method of claim 15, wherein transmitting the first information and transmitting the second information comprises:
transmitting a first message comprising the first information and an indication that the second information is in a second message, wherein provision of the at least one service of the one or more first services is based at least in part on the first message; and
transmitting the second message comprising the second information.

17. The method of claim 15, wherein the first information further comprises an identifier of the first network operator and the second information further comprises an identifier of the second network operator.

18. The method of claim 15, further comprising:
transmitting an indication of the one or more first services to a second network entity associated with the first network operator; and
transmitting an indication of the one or more second services to a third network entity associated with the second network operator, wherein the second network entity and the third network entity are higher-tier network entities relative to the first network entity.

19. The method of claim 15, further comprising:
receiving an indication of a respective network operator identifier associated with the UE based at least in part on transmitting the first information and the second information; and
outputting a trigger message to a third network entity based at least in part on the respective network operator identifier being the same as a network operator associated with the third network entity, the trigger message associated with a synchronization signal block or a system information block.

20. A first network entity for wireless communications, comprising:
means for transmitting first information that indicates one or more first services supported by the first network entity, wherein the one or more first services are associated with a first network operator;
means for transmitting second information that indicates one or more second services supported by the first network entity, wherein the one or more second services are associated with a second network operator; and
means for providing at least one service of the one or more first services or the one or more second services to a user equipment (UE), wherein provision of the at least one service is based at least in part on the UE being associated with the first network operator or the second network operator.
